(19) United States
(12) Patent Application Publication
(10) Pub. No.: US 2024/0427556 A1
(43) Pub. Date: Dec. 26, 2024

(54) METHOD AND APPARATUS FOR RANDOM NUMBER GENERATION

(71) Applicant: ARRIS Enterprises LLC, Horsham, PA (US)

(72) Inventor: Lex Aaron ANDERSON, Auckland (NZ)

(73) Assignee: ARRIS Enterprises LLC, Horsham, PA (US)

(21) Appl. No.: 18/638,071

(22) Filed: Apr. 17, 2024

Related U.S. Application Data
(60) Provisional application No. 63/522,937, filed on Jun. 23, 2023.

(51) Int. Cl. G06F 7/58

(52) U.S. Cl. CPC G06F 7/588

(57) ABSTRACT

A method and apparatus for generating a random entropy pool in a processing system executing a plurality of processing threads is disclosed. Each of the processing threads having a processing result completed in non-deterministic temporal order in relation to other processing threads. In one embodiment, the method comprises computing, in a first processing thread, a first processing thread state value according to a shapeless mixing operation operating on an initial thread state value and the processing result, computing, in another processing thread having a subsequently completed processing result, another processing thread state value according to a further shapeless mixing operation operating on another initial thread state value or a previously computed processing thread state value and the subsequently completed processing result; and computing a portion of the entropy pool from the processing thread state value and the another processing thread state value.

### CROSS-REFERENCE TO RELATED APPLICATIONS

The present claims priority to U.S. Provisional Application No. 63/522,937 filed Jun. 23, 2023, the contents of which are each incorporated herein by reference in their entirety.

### BACKGROUND

### 1. Field

The present disclosure relates to systems and methods for performing cryptographic operations, and in particular to a system and method for generating random numbers.

### 2. Description of the Related Art

Cryptographic algorithms rely on the assumption that a high-quality source of random numbers is available. Such random numbers are used in key generation, nonces, random tokens, globally unique identifiers, and other secrets that are fundamental to the security of a cryptographic system.

In many instances, the generation of the random number must be accomplished in a limited time period, for example, when boot loading or during system initialization. This presents a problem in accumulating sufficient entropy for the generation of random numbers within the required time.

Further, attacks have been successfully carried out against software based true random number generator (TRNG) systems such as the LINUX random number generator (LRNG) and BRILLO, with lower bound complexity of as little as 2⁴⁰. A key weakness in these approaches is the algebraic structure of the mixing functions, which are typically linear operations such as linear feedback shift-registers (LFSRs).

Also, current white-box cryptographic implementations rely on external sources of entropy for generating protected keys. Although white-box cryptographic implementations can be made quite secure, the quality (randomness) of random numbers obtained from external sources is beyond the control of the white-box. Further, even if high-quality sources of randomness are available externally, they are vulnerable to interception before they are passed into the encoded domain of the white-box.

### SUMMARY

To address the requirements described above, this document discloses a method and apparatus for generating a random entropy pool in a processing system executing a plurality of processing threads. Each of the processing threads having a processing result is completed in non-deterministic temporal order in relation to other processing threads. In one embodiment, the method comprises computing, in a first processing thread, a first processing thread state value according to a shapeless mixing operation operating on an initial thread state value and the processing result, computing, in another processing thread having a subsequently completed processing result, another processing thread state value according to a further shapeless mixing operation operating on another initial thread state value or a previously computed processing thread state value and the subsequently completed processing result; and computing a portion of the entropy pool from the processing thread state value and the another processing thread state value. Another embodiment is evidenced by one or more processors executing processor instructions stored in a communicatively coupled memory that perform the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram illustrating one embodiment of a random number generator with inputs from entropy sources;

FIG. 2 is a diagram of an exemplary random number generator;

FIG. 3 is one embodiment of an simplified mixing function;

FIG. 4 is a diagram illustrating output generation;

FIG. 5 is a diagram illustrating an embodiment of an improved random number generator;

FIG. 6 is an example of the application of shapeless mixing operations in generating a random entropy pool;

FIG. 7 is a diagram illustrating one embodiment of how processing results from processing threads are provided to the entropy pool by each thread;

FIG. 8 is a diagram illustrating exemplary operations that can be used to compute an entropy pool for use in generating a random number; and

FIG. 9 illustrates an exemplary computer system that could be used to implement processing elements of the geolocation system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

A true random number generator (TRNG) with entropy inputs produces bits non-deterministically as the internal state is frequently refreshed with unpredictable data from one or more entropy sources.

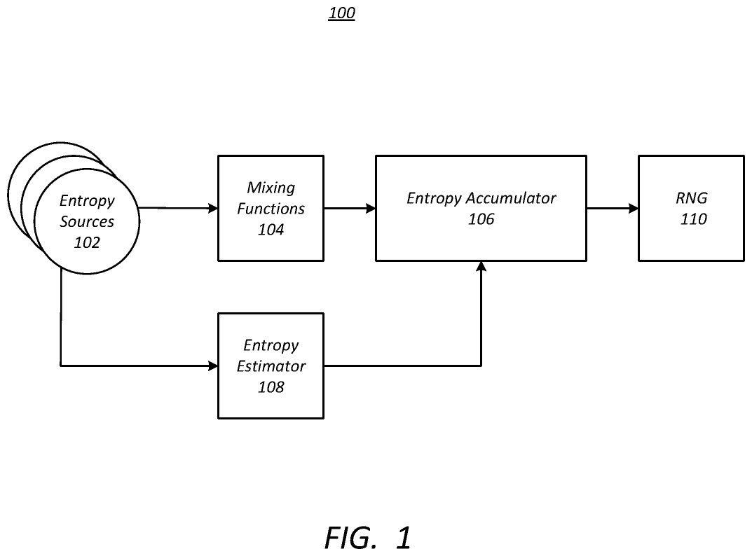

FIG. 1 is a diagram illustrating one embodiment of a pseudorandom number generator (PRNG) 100 with inputs from entropy sources 102, which may comprise one or more internal or external sources of randomness. The inputs from the entropy sources 102 are provided to a harvesting device such as an entropy accumulator 106 after application of a mixing function 104. The entropy accumulator 106 accepts the mixed inputs of the entropy sources 102 and accumulates the entropy of those inputs into a state. A post processor retrieves data from the entropy accumulator 106, and post-processes that data to generate the output, which is a random number. Entropy estimator 108 estimates the entropy of the data in the entropy accumulator 106 and provides that input for use in connection with the entropy accumulator 106. Random number generator (RNG) 110 generates a random number from the bits in the entropy accumulator 106.

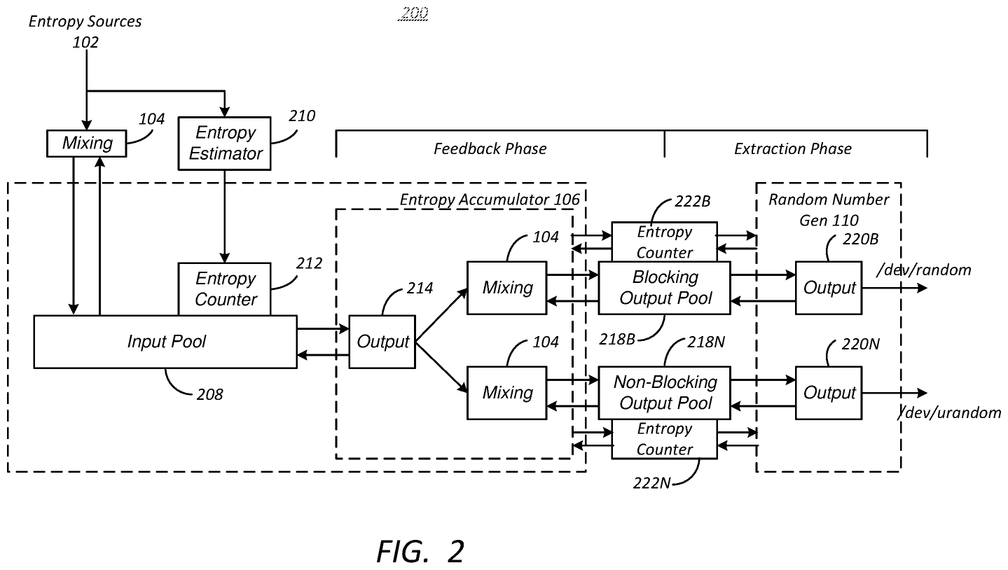

FIG. 2 is a diagram of an exemplary PRNG 100, namely, a PRNG used in a LINUX operating system, or LPRNG 200. Further details regarding the LPRNG 200 can be found in the publication Lacharme, Patrick & Rock, Andrea & Strubel, Vincent & Videau, Marion. (2012), “The Linux Pseudorandom Number Generator Revisited,” which is hereby incorporated by reference herein.

### General Structure

Unlike others PRNGs, the internal state of the Linux PRNG 200 is composed of three pools, namely the input pool 208, the blocking output pool 218B and the nonblocking pool 218N. In this description the blocking output pool 218B and the nonblocking output pool 218N are also alternately also referred as output pools 218, depending on the context.

The Linux PRNG 200 is designed to perform the collection of entropy inputs as efficiently as possible, and therefore uses linear mixing functions instead of a more usual hash functions. The security of the Linux PRNG 200 strongly relies on the cryptographic primitive Sha-1, which is used for output generation and entropy transfers between the input pool and the output pools.

### Entropy Sources and Accumulation

In this example, the entropy sources 102 comprise entropy samples that are collected from system events inside the kernel, asynchronously and independently from output generation. Entropy samples are added to the input pool using the mixing function 104 described further below. The entropy counter 212 of the input pool 208 is incremented according to the estimated entropy of the mixed data. The same mixing function 104 is also used when transferring data from the input pool 208 to one of the output pools 218, when the latter requires more entropy for output generation. In that case, the algorithm assumes full entropy of the data, and the entropy counters for each of the output pools 218 is incremented by the number of transferred bits.

### Entropy Estimator

Entropy estimator 210 provides an estimate of the available entropy. The estimation of available entropy is crucial, particularly for output random numbers sourced from entropy in the blocking output pool 218B. It must be fast and provide an accurate estimation of whether the corresponding output pool 218 contains enough entropy to generate unpredictable output data. It is important not to overestimate the entropy provided by input sources.

Entropy estimation is based on a few reasonable assumptions. It is assumed that most of the entropy of the input samples is contained in their relative timing. Both the cycle and jiffies counts can be seen as a measure of timing, however the jiffies count has a much coarser granularity. The Linux PRNG 200 bases its entropy estimation on the jiffies count only, which leads to a pessimistic estimation. The estimator may considers several different sources, for example, user input, interrupts, and disk I/O. Each interrupt request (IRQ) number can be seen as a separate source. The estimator 210 keeps track of the jiffies count of each entropy source 102 separately. The values of the jiffies count are always increasing, except in the rare case of an overflow. The entropy is estimated from the jiffies difference between two events.

### The Mixing Function

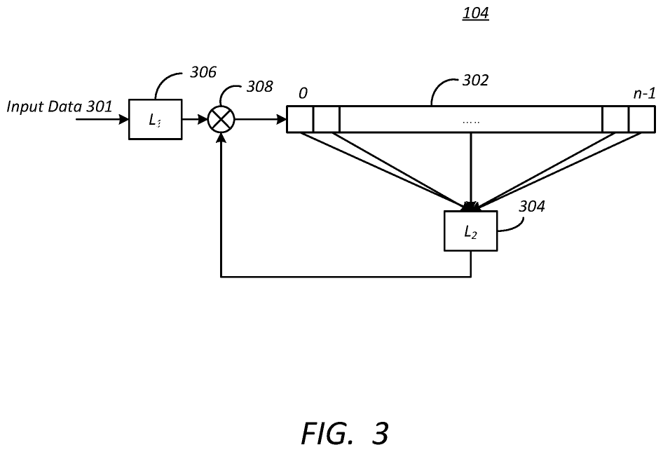

FIG. 3 is one embodiment of an simplified mixing function 104. The mixing function 104 mixes one byte at a time by extending the byte into a 32 bit word, then rotating it by a changing factor, and finally mixing it into the pool by using a linear shift register via mixer 308. Linear function L1 306 takes an 8-bit input y, extends it to 32 bits in register 302, rotates it, and applies a multiplication, for example, by means of a twist table. Linear function L2 304 represents a feedback function, typically a feedback polynomial.

### Output Generation

The random data generation is done in blocks of 10 output bytes. For each output block, 20 bytes, produced during the process, are injected and mixed back into the source output pool 218 to update that output pool 218. When k bytes need to be generated, the generator first checks whether there is enough entropy in the current output pool 218 according to its entropy counter 222. If this is the case, k output bytes are generated from this associated output pool 218 and the entropy counter 222 is decreased by k bytes. Otherwise, if there is not enough entropy in the output pool 218, the LPRNG 200 requests a transfer of k bytes of entropy from the input pool 208 into the output pool 218. The output function 214 used for output generation and transfer is more fully described below.

The transfer is done by first producing kt bytes from the input pool 208 using the output function 214, then injecting those kt bytes into the output pool 218 with the mixing function 104. The kt value depends on the entropy count hl (in bits) of the input pool 208 and on the requesting output pool 218. If the request comes from the blocking pool 218B, then kt=min (lhI/8J, k), whereas if it comes from the nonblocking pool 218N, kt=min (lhI/8J-16, k). This means that the input pool 208 does not generate more bytes than its entropy counter 212 allows. Moreover, if the request comes from the nonblocking pool 218N it leaves at least 16 bytes of entropy in the input pool 208. If kt<8, no bytes are transferred to avoid frequent work for very small amounts of data.

After the transfer, the entropy counter 217 of the input pool 208 and the entropy counter 222B of the blocking output pool 218B and entropy counter 222N of the non-blocking output pool 218N are respectively reduced and increased by 8 kt bits. Due to this transfer policy, the entropy counters 222 of the output pools 218 remain most of the time close to zero between two output requests, since only as many bytes are transferred as are needed for the output. No output is generated from the output pool 218 before all kt bytes have been injected. During the injection, the output pool 218 is shifted kt times by the mixing function 104. For every 10 bytes generated from the output pool 220, 20 bytes are mixed back and the output pool 218 gets shifted 20 times. Thus, to produce k bytes, the output pool 218 is shifted at least 2k times, when no transfer of entropy data is necessary, and at most 2k+kt times, if kt bytes are transferred from the input pool 208.

Let hO denote the entropy counter of the output pool after the entropy transfer. In the case of/dev/random, if hO<8k, and there are less than 8 bytes of estimated entropy in the input pool 208, output generation stops after lhO/8J bytes, and only resumes when enough entropy has been mixed into the input pool 208 for a transfer to occur. In contrast, /dev/urandom continues to output data until all k bytes have been produced, regardless of whether the input pool 208 had enough entropy to satisfy all transfer requests.

The output function 214 is used in two cases: When data is transferred from the input pool 208 to one of the output pools 218 and when output data is generated from one of the output pools 218.

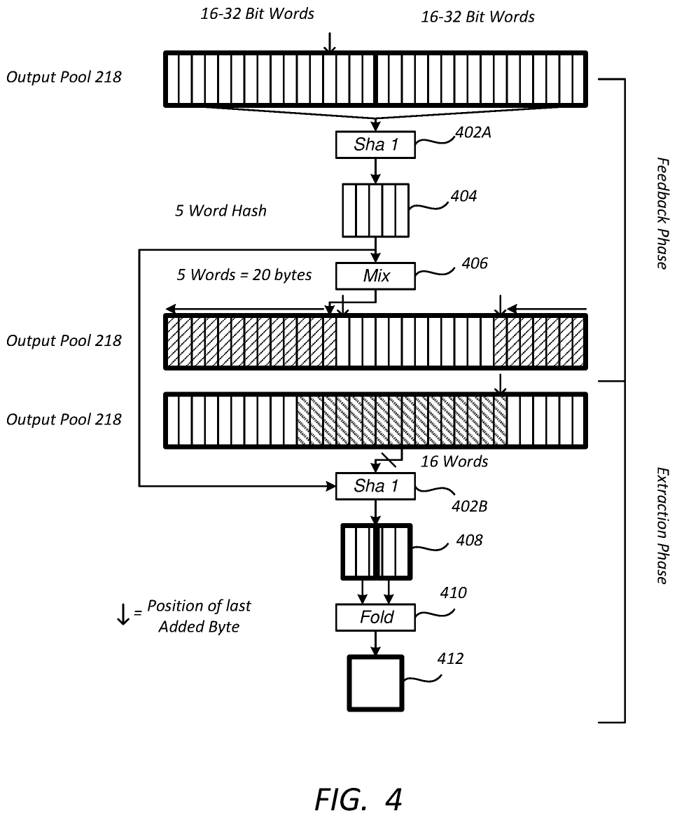

FIG. 4 is a diagram illustrating one example of output generation. The output function 214 uses a first Sha-1 hash function 402A in both a feedback phase and an extraction phase. In the feedback phase, all the bytes of the output pool 218 are fed into a first Sha-1 hash function 402A, to produce a 5-word (20-byte) hash 404 or digest. These 20 bytes are mixed back into the output pool 218 by using mixing function 406. Consequently, the output pool 218 is shifted 20 times for each feedback phase. This affects twenty consecutive words (640 bits) of the output pool 218.

Once mixed with the output pool 218 content, the 5 words computed in the feedback phase are used as an initial value or chaining value when hashing another 16 words from the output pool 218. These 16 words overlap with the last word changed by the feedback data. In the case of an output pool 218 (pool length=32 words), they also overlap with the first three changed words. The 20 bytes of output 408 from this second hash 402B are folded in half to compute the 10 bytes to be extracted: if w [m . . . n] denotes the bits m, . . . , n of the word w, the folding operation 410 of the five words w0, w1, w2, w3, w4 is done by w0⊕w3, w1⊕w4, w2 [0 . . . 15]⊕w2 [16 . . . 31] to generate output 412. Finally, the estimated entropy counter 222 of the affected output pool 218 is decremented by the number of generated bytes.

While effective, RNGs such as the LRNG have weaknesses. Attacks have been successfully carried out against software-based TRNG systems such as the LRNG and BRILLO with lower-bound complexity of as little as 2⁴⁰. A key weakness in the LRNG and similar RNGs is the algebraic structure of the mixing functions, which are typical linear operations such as LSFRs. Another problem with such RNGs is efficiency. Often, a random number is required shortly after boot loading or system initialization, at which point sufficient entropy may not have been accumulated. The LRNG attempts to solve this problem by including both the blocking output pool 218B and the non-blocking output pool 218N.

The random number retrieved using the/dev/random command is generated by reading from the blocking output pool 218B and limits the number of generated bits according to the estimation of the entropy available in the LRNG. Reading from this device is blocked when the LRNG does not have enough entropy, and resumed when enough new entropy samples have been mixed into the input pool 208. It is intended for user space applications in which a small number of high quality random bits is needed. The random number retrieved using the/dev/urandom command is generated by reading from the nonblocking output pool 218N and generates as many bits as the user asks for without blocking. It is meant for the rapid generation of large amounts of random data, albeit with less entropy.

Finally, current white-box cryptographic implementations rely on external sources of entropy for generating protected keys. The quality (e.g. randomness) of the numbers provided from such external sources are beyond the control of the whitebox and cannot be assured. Finally, even if high-quality sources of randomness are available externally, they are vulnerable to interception before they are passed into the encoded domain of the whitebox.

### Improved Random Number Generator

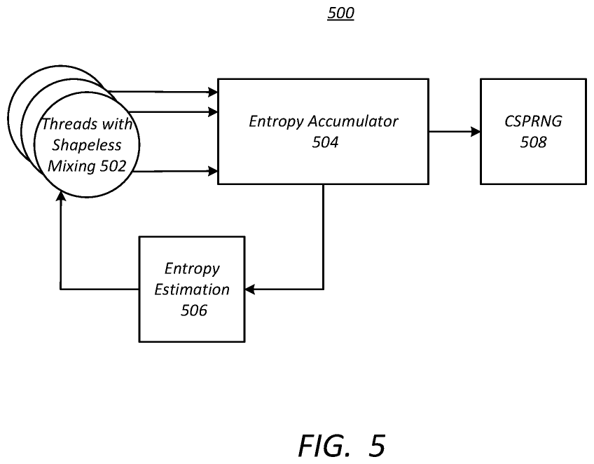

FIG. 5 is a diagram illustrating an embodiment of an improved RNG 500. The improved RNG 500 generates true random numbers and does so more rapidly than prior art RNGs. The RNG 500 uses mixing functions based on “shapeless” quasigroup algebras that are built from operations that are non-commutative, non-associative, and non-linear. Unlike the RNG 100 illustrated in FIG. 1, The mixing operations take place within the threads 502 themselves and this a non-deterministic permutation layer is inherently present due to race conditions between the threads 502. This effectively parallelizes entropy accumulation while also increasing the cost of recovering the seed state. Entropy is accumulated by the entropy accumulator 504, which may include an input pool such as the input pool and/or the output pool 218 depicted in FIG. 1. Hereinafter, the entropy accumulator 504 will be discussed as being implemented using an entropy pool. Generator 508 extracts bits from the entropy accumulator 504 to generate the random number. As the RNG 500 rapidly accumulates entropy, the entropy estimator 506 is optional.

### Shapeless Mixing Operations

Quasigroup algebras that are simultaneously non-commutative, non-associative, and non-linear are classified as shapeless. For example, with “X” denoting a standard multiplication operation, an ordinary algebra is associative, and commutative, as illustrated below:

Associativity: If A, B, and C are the operands, in a standard algebraic multiplication operation (A×B)×C=A×(B×C). For example, if A=3, B=4, and C=5: (3×4)×5=3×(4×5)=60.

Commutativity: In a standard multiplication operation, A×B×C=C×B×A=B×A×C=A×C×B. For example: 3×4×5=5×4×3=5×3×4=3×5×4=60

However, for a shapeless mixing operation ⊗, the associativity and commutativity properties do not apply. Specifically, with respect to associativity: (A⊗B)⊗C≠A⊗(B⊗C). For example: (3⊗4)⊗5=97 and 3⊗(4⊗5)=128. With respect to commutativity: A⊗B⊗C≠C⊗B⊗A≠B⊗A⊗C≠A⊗C⊗B. For example: 3⊗4⊗5=97 and 3⊗5⊗4=11

The properties of shapeless operations of quasigroup algebras are ideal for cryptographic applications because their inherent lack of algebraic structure presents a significant challenge in terms of cryptanalysis.

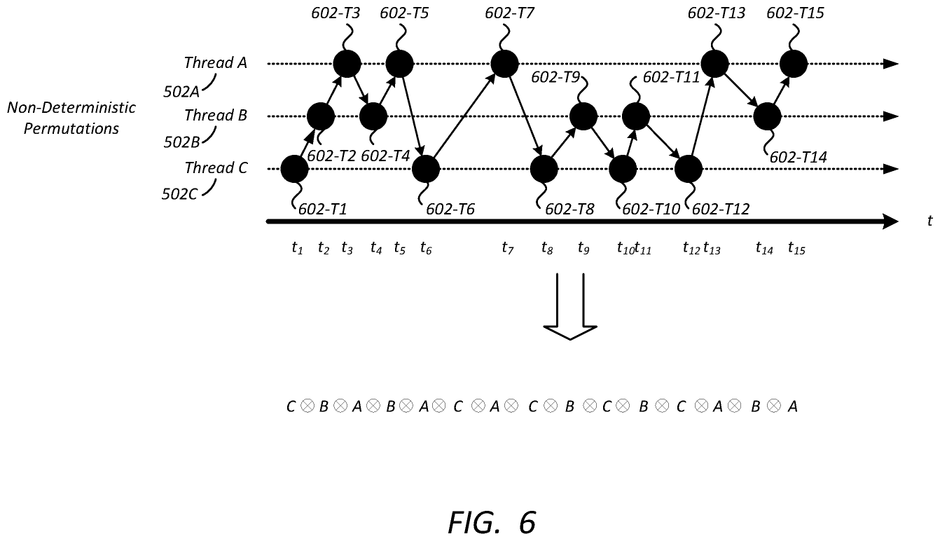

FIG. 6 is an example of the application of shapeless mixing operations in generating a random entropy pool 504, which can be used to generate random numbers. Illustrated is a plurality of processing threads 502 that includes thread A 502A, thread B 502B, and thread C 502C. The processing threads 502 are independent, and preferably executed by independent central processing unit (CPU) cores. Over time, each processing thread 502 produces a processing result such as processing results 602-T1-602-T15, temporally indicated on each of the lines of threads A 502A, thread B 502B and thread C 502C at times t₁-t₁₅. For example, the first processing result 602 completed between thread A 502A, thread B 502B, and thread C 502C is processing result 602-T1 produced by thread C 502C at time t₁. Each shapeless mixing operation runs in its own processing thread 502 and operates on an entropy pool 504 common to the treads 502. The time t at which a processing result 602 (which may be an intermediate result or a final result) occurs for each thread 502 is random because even if the processing is performed according to deterministic instruction steps, when such processing instructions are actually executed and completed varies depending upon factors such as heat, other parallel processing operations, user input, sensor inputs, and other factors. Such timing differences change the sequence of the mixing operations. Accordingly, the processing results 602 from each processing thread 502 are completed in non-deterministic temporal order (that is, the temporal order of the completing of each processing result may be C⊗B⊗A⊗B⊗A⊗C⊗A⊗C⊗B⊗C⊗A⊗B⊗A as illustrated or any of a number of non-deterministic permutations of the processing result).

Due to the properties of the operation ⊗ (a shapeless mixing operation of a quasigroup algebra), if the sequence of operands of the mixing operations (e.g. the processing result from thread C 502 appearing first (at t₁), the processing result from thread B 502B appearing second (at time t₂) and the processing result from thread A 502A appearing third (at time t₃)) changes even slightly, the result of the computation differs in a non-linear manner, thus shapeless mixing over multiple threads is essentially a deterministic permutation over multiple non-linear operations.

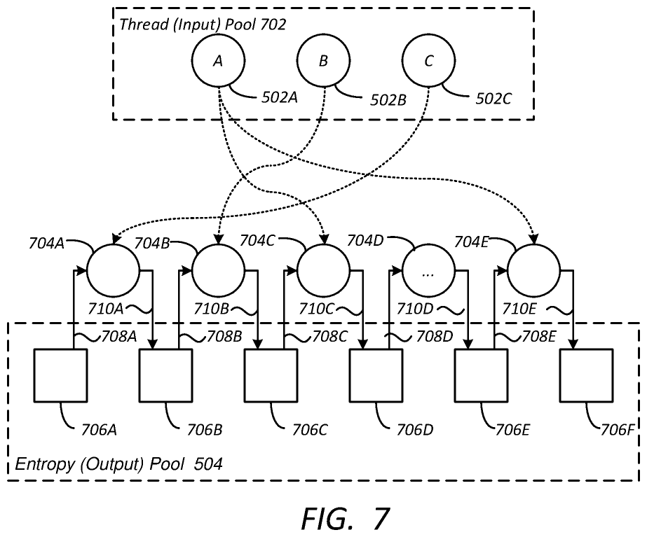

FIG. 7 is a diagram illustrating one embodiment of how processing results 602 from processing threads 502 are provided to the entropy pool 504 by each thread. Each thread 502 contains a shapeless mixing operation that takes inputs from and provides output to the entropy pool 504, which is a cyclic buffer of a predetermined size. In the illustrated example, there are three threads in the thread pool 702, specifically thread A 502A, thread B 502B, and thread C 502C, but in practice, the number of threads 502 in the thread pool 702 may be an arbitrarily large number, for example, based on CPU cores.

The entropy pool 504 starts with an initial (nominally ordered) state. The processing thread 502 having the most recent processing result 602 following initiation (in the illustrated case, thread C 502C) takes an input (e.g. input from entropy pool portion 706A) from the entropy pool 504 and performs the shapeless mixing operation 704 (such as the & operation discussed earlier) using the input from the entropy pool 504 and the processing result 602 (in the illustrated processing result 602-T1) of the processing thread 502 (in the illustrated case thread C 504C). The processing thread 502 then writes the result back to the entropy pool 504.

Next, the processing thread 502 having a subsequent (in one embodiment, the next) processing result 602 following initiation (in the illustrated case, thread B 502B) takes an input (e.g. input from entropy pool portion 706B) from the entropy pool 504 and performs the shapeless mixing operation 704 (which can be the same shapeless missing operation as used previously or a different shapeless mixing operation) using the input from the entropy pool 504 and the processing result 602 (in the illustrated case result 602-T2) of the processing thread 502 (in the illustrated case thread B 504B). The processing thread 502 then writes this result back to the entropy pool 504.

This process is repeated for subsequent processing thread 502 results. Each repetition of the process increases the entropy in the entropy pool, and after a predetermined number of iterations, a random number can be extracted from the entropy pool, for example, by a pseudo random number generator 110 performing the extraction and generation.

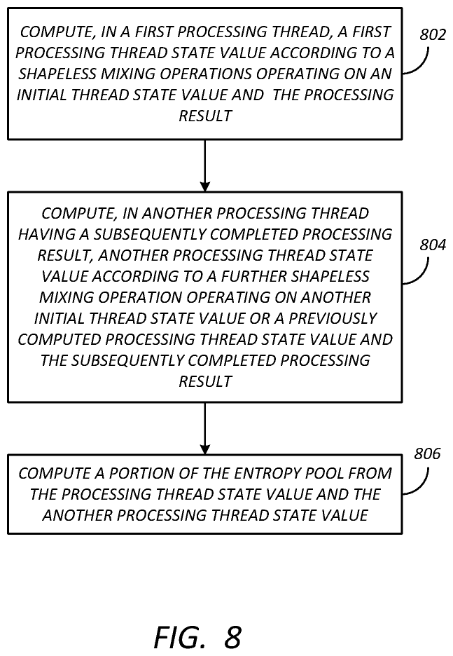

FIG. 8 is a diagram illustrating exemplary operations that can be used to compute an entropy pool 504 for use in generating a random number. In block 802, a first processing thread 502A computes a first processing thread state value 710A according to a shapeless mixing operation 704A operating on an initial thread state value 708A and the processing result from the first processing thread 502A.

In block 804, another processing thread state value 710B is computed by another processing thread 502B having a subsequently completed processing result according to a further shapeless mixing operation 704B operating on another initial thread state value or a previously computed processing thread state value 708B and the subsequently completed processing result. In one embodiment, the further shapeless mixing operation 704B as well as all subsequent shapeless mixing operations 704 is in fact the same shapeless mixing operation as recited in the previous step (e.g. shapeless mixing operation 704A).

In block 806, a portion of the entropy pool 504 is computed from the processing thread state value 710A and the another processing thread state value 710B. This process is repeated as each processing thread 502 completes a processing result, with initial thread values or previously computed processing thread state values 708 being read from the entropy pool 504, another processing thread state value being computed from the with initial thread values or previously computed processing thread state values 708 and the processing result, and written back to the entropy pool 504.

For example, the operations of block 802 may be performed by reading, in the first processing thread 502C having the processing result, the initial thread state value 708A from a first portion of the entropy pool 706A, and writing in the first processing thread 502C having the processing result, the first processing thread state value 710A to a second portion of the entropy pool 706B. Also, the operations of block 804 may be performed by reading, in the processing thread having the subsequently completed processing result 502B, the processing thread state value 710A from the second portion of the entropy pool 706B, computing, in the same processing thread 502B, another processing thread state value 710B according to the further shapeless mixing operation 704B operating on another initial thread state value or the processing thread state value 710A and the subsequently completed processing result, and writing, in the same processing thread 502B, the another processing thread state value 710B to a third portion of the entropy pool 706C. In this example, the computed first processing thread state value 710A is written to the second portion of the entropy pool 706B (thus overwriting any initial value that may have been stored in that second portion of the entropy pool 706B), then that computed first processing thread state value 710A applied to the further shapeless mixing operation 704B along with the subsequently completed processing result from processing thread 502A.

In one embodiment, which portion of the entropy pool 504 are read from and written to is determined according to counters. For example, the portions of the entropy pool 504 that are read from can be determined according to a counter (either external or internal to each thread), and the portions of the entropy pool that are written to can be determined according to a counter that is internal to the thread in the case where the read counter is external to the thread and external to the thread in the case where the read counter is internal to the thread. Both counters can be indexed to the size of the entropy pool 504 (e.g. the entropy pool modulo the entropy pool size), with larger entropy pools 504 having larger counters. Since the order of thread execution is non-deterministic and the mixing operations are shapeless, after a predetermined iteration count, the pool is considered to be sufficiently randomized.

Initially, the entropy pool 504 (and hence, each entropy pool portion 706) is populated with initial thread state values, and as processing threads 502 produce processing thread results, initial thread state values are read from the entropy pool portion 706 as determined by the internal counter, with the result of the shapeless mixing operation 704 applied to the processing thread result and the initial thread state values written back to the portion of the entropy pool 706 defined by the global incrementing counter. Hence, when a processing thread 502 reads from a portion of the entropy pool (as defined by the internal counter), that value will be the initial processing thread state value (if a subsequent processing thread state value has not been written to that portion of the entropy pool) or the processing thread state value most recently written by another processing thread to that portion of the entropy pool 706. For example, the value 708B read from entropy pool portion 706B may be an previously stored initial thread state value or the previously computed processing thread state value 710A, depending on whether entropy pool portion 706B has had its initial thread state value overwritten by a previously computed processing thread state value.

Each processing thread 502 may use the same or entirely different shapeless quasigroup mixing operations 704, since shapeless quasigroups are inexpensive to generate. Also, non-commutative and non-associative quasigroup algebras share many common properties with fully-homomorphic white-box cryptography, and such group algebras may be defined so as to generate random numbers or entropy pools that are encoded for use in subsequent whitebox operations, thus preventing interception of plaintext random numbers before delivery to the whitebox. In particular, shapeless quasigroup algebras are directly compatible with table-based dynamic white-box encodings (in current usage), meaning any generated entropy is inherently white-box encoded and requires no exposure of cleartext input, internal, or output states.

Sensor samples, such as core temperature, fan speeds, I/O metrics, and other physical measures can be directly incorporated into the shapeless mixing model to add further entropy over time. Even an adversary with control over one or more of these physical inputs will not be able to reduce TRNG entropy below the baseline generated solely by scheduling “jitter”.

The efficiency of this approach allows entropy accumulation to occur quickly and to proceed over the lifetime of the system, either running continuously or on-demand based on parameterized settings for entropy estimation. This enables high quality entropy to be available earlier and more frequently than traditional approaches. For example, while LRNG can achieve low quality entropy in 30-60 seconds, the foregoing approach can produce equivalent quality entropy in 9-15 seconds. Further, high quality entropy may be produced in 18-32 seconds, while LRNG requires well over 60 seconds to achieve the same entropy quality.

Exhaustive statistical tests against the standard NIST SP800-90A randomness tests on a wide range of platforms and devices have shown that the foregoing approach passes all statistical randomness tests.

### Hardware Environment

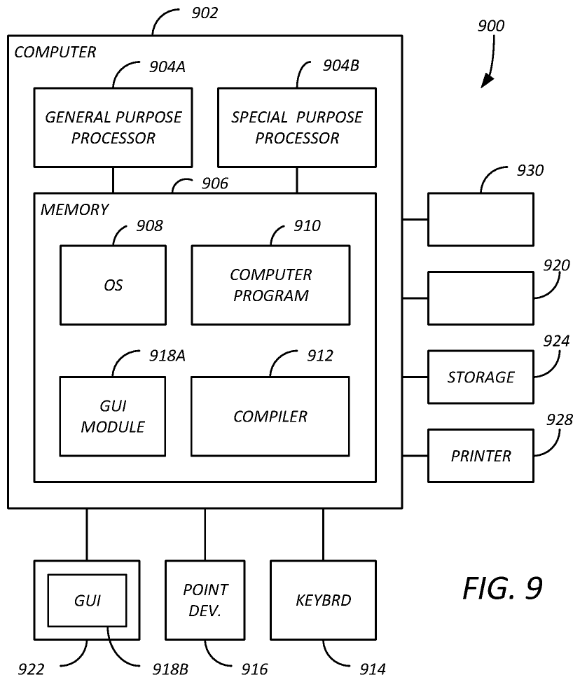

FIG. 9 illustrates an exemplary computer system 900 that could be used to implement processing elements of the above disclosure, including the any of the processors computing the processing threads. The computer 902 comprises a processor 904 and a memory, such as random access memory (RAM) 906. The computer 902 is operatively coupled to a display 922, which presents images such as windows to the user on a graphical user interface 918B. The computer 902 may be coupled to other devices, such as a keyboard 914, a mouse device 916, a printer 928, etc. Of course, those skilled in the art will recognize that any combination of the above components, or any number of different components, peripherals, and other devices, may be used with the computer 902.

Generally, the computer 902 operates under control of an operating system 908 stored in the memory 906, and interfaces with the user to accept inputs and commands and to present results through a graphical user interface (GUI) module 918A. Although the GUI module 918B is depicted as a separate module, the instructions performing the GUI functions can be resident or distributed in the operating system 908, the computer program 910, or implemented with special purpose memory and processors. The computer 902 also implements a compiler 912 which allows an application program 910 written in a programming language such as COBOL, C++, FORTRAN, or other language to be translated into processor 904 readable code. After completion, the application 910 accesses and manipulates data stored in the memory 906 of the computer 902 using the relationships and logic that was generated using the compiler 912. The computer 902 also optionally comprises an external communication device such as a modem, satellite link, Ethernet card, or other device for communicating with other computers.

In one embodiment, instructions implementing the operating system 908, the computer program 910, and the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, etc. Further, the operating system 908 and the computer program 910 are comprised of instructions which, when read and executed by the computer 902, causes the computer 902 to perform the operations herein described. Computer program 910 and/or operating instructions may also be tangibly embodied in memory 906 and/or data communications devices 930, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure.

A system of one or more computers can be configured to perform particular operations or actions by virtue of having software, firmware, hardware, or a combination of them installed on the system that in operation causes or cause the system to perform the actions has been described. One or more computer programs can be configured to perform particular operations or actions by virtue of including instructions that, when executed by data processing apparatus, cause the apparatus to perform the actions. One general aspect includes a method of generating a random entropy pool in a processing system executing a plurality of processing threads. The method also includes computing, in a first processing thread, a first processing thread state value according to a shapeless mixing operation operating on an initial thread state value and the processing result; computing, in another processing thread having a subsequently completed processing result, another processing thread state value according to a further shapeless mixing operation operating on another initial thread state value or a previously computed processing thread state value and the subsequently completed processing result; and computing a portion of the entropy pool from the processing thread state value and the another processing thread state value. Other embodiments of this aspect include corresponding computer systems, apparatus, and computer programs recorded on one or more computer storage devices, each configured to perform the actions of the methods.

Implementations may include one or more of the following features:

The method above wherein: the further shapeless mixing operation is the shapeless mixing operation.

Any of the above methods, wherein: the processing system includes a plurality of processors, each of the plurality of processors executing a differing one of the plurality of processing threads.

Any of the above methods, wherein: computing, in the first processing thread having the processing result, the processing thread value according to the shapeless mixing operation operating on the initial thread state value and the processing result further includes: reading, in the first processing thread having the processing result, the initial thread state value from the entropy pool; and writing, in the first processing thread having the processing result, the first processing thread state value to the entropy pool. Further where computing, in the another processing thread having the subsequently completed processing result, the another processing thread state value according to the further shapeless mixing operation operating on the another initial thread state value or the previously computed processing thread state value and the subsequently completed processing result includes: reading, in the processing thread having the subsequently completed processing result, the processing thread state value from the entropy pool; computing, in the processing thread having the subsequently completed processing result, the another processing thread state value according to the further shapeless mixing operation operating on another initial thread state value or the processing thread state value and the subsequently completed processing result; and writing, in the processing thread having the subsequently completed processing result, the another processing thread state value to the entropy pool.

Any of the above methods, wherein: the initial thread state value is read from a first portion of the entropy pool; the processing thread state value is written to a second portion of the entropy pool; the processing thread state value is read from the second portion of the entropy pool; and the another processing thread state value is written to a third portion of the thread pool.

Any of the above methods, wherein: the first portion of the entropy pool and the third portion of the entropy pool are determined according to a first counter, and the second portion of the entropy pool is determined according to a second counter, where the first counter is one of a counter internal to the thread and a counter external to the thread, and the second counter is the other of the counter internal to the thread and the counter external to the thread.

Any of the above methods, wherein: the first counter and the second counter are indexed to a size of the entropy pool.

Any of the above methods, further comprising: extracting a plurality of random bits from the entropy pool; generating a random number according to the plurality of random bits; and performing a cryptographic operation according to the random number.

Implementations of the described techniques may include hardware, a method or process, or computer software on a computer-accessible medium.

Another general aspect includes an apparatus for generating a random entropy pool in a processing system executing a plurality of processing threads. The apparatus includes at least one processor; a memory, communicatively coupled to the at least one processor in which the memory stores processor instructions. The processor instructions include processor instructions for: computing, in a first processing thread, a first processing thread state value according to a shapeless mixing operation operating on an initial thread state value and the processing result; computing, in another processing thread having a subsequently completed processing result, another processing thread state value according to a further shapeless mixing operation operating on another initial thread state value or a previously computed processing thread state value and the subsequently completed processing result; and computing a portion of the entropy pool from the processing thread state value and the another processing thread state value. Other embodiments of this aspect include corresponding computer systems, apparatus, and computer programs recorded on one or more computer storage devices, each configured to perform the actions of the methods.

Implementations may include one or more of the following features.

The apparatus above, wherein: the further shapeless mixing operation is the shapeless mixing operation.

Any apparatus above, wherein: the processing system includes a plurality of processors, each of the plurality of processors executing a differing one of the plurality of processing threads.

Any apparatus above, wherein: the processor instructions for computing, in the first processing thread having the processing result, the processing thread value according to the shapeless mixing operation operating on the initial thread state value and the processing result further includes processor instructions for: reading, in the first processing thread having the processing result, the initial thread state value from the entropy pool; and writing, in the first processing thread having the processing result, the first processing thread state value to the entropy pool; the processor instructions for computing, in the another processing thread having the subsequently completed processing result, the another processing thread state value according to the further shapeless mixing operation operating on the another initial thread state value or the previously computed processing thread state value and the subsequently completed processing result includes processor instructions for: reading, in the processing thread having the subsequently completed processing result, the processing thread state value from the entropy pool; computing, in the processing thread having the subsequently completed processing result, the another processing thread state value according to the further shapeless mixing operation operating on another initial thread state value or the processing thread state value and the subsequently completed processing result; and writing, in the processing thread having the subsequently completed processing result, the another processing thread state value to the entropy pool.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of generating a random entropy pool in a processing system executing a plurality of processing threads, each of the processing threads having a processing result completed in non-deterministic temporal order in relation to other processing threads, comprising:
computing, in a first processing thread, a first processing thread state value according to a shapeless mixing operation operating on an initial thread state value and the processing result;
computing, in another processing thread having a subsequently completed processing result, another processing thread state value according to a further shapeless mixing operation operating on another initial thread state value or a previously computed processing thread state value and the subsequently completed processing result; and
computing a portion of the entropy pool from the processing thread state value and the another processing thread state value.

2. The method of claim 1, wherein the further shapeless mixing operation is the shapeless mixing operation.

3. The method of claim 2, wherein the processing system comprises a plurality of processors, each of the plurality of processors executing a differing one of the plurality of processing threads.

4. The method of claim 3, wherein:
computing, in the first processing thread having the processing result, the processing thread value according to the shapeless mixing operation operating on the initial thread state value and the processing result further comprises:
reading, in the first processing thread having the processing result, the initial thread state value from the entropy pool; and
writing, in the first processing thread having the processing result, the first processing thread state value to the entropy pool;
computing, in the another processing thread having the subsequently completed processing result, the another processing thread state value according to the further shapeless mixing operation operating on the another initial thread state value or the previously computed processing thread state value and the subsequently completed processing result comprises:
reading, in the processing thread having the subsequently completed processing result, the processing thread state value from the entropy pool;
computing, in the processing thread having the subsequently completed processing result, the another processing thread state value according to the further shapeless mixing operation operating on another initial thread state value or the processing thread state value and the subsequently completed processing result; and
writing, in the processing thread having the subsequently completed processing result, the another processing thread state value to the entropy pool.

5. The method of claim 4, wherein:
the initial thread state value is read from a first portion of the entropy pool;
the processing thread state value is written to a second portion of the entropy pool;
the processing thread state value is read from the second portion of the entropy pool; and
the another processing thread state value is written to a third portion of the thread pool.

6. The method of claim 5, wherein the first portion of the entropy pool and the third portion of the entropy pool are determined according to a first counter, and the second portion of the entropy pool is determined according to a second counter, wherein the first counter is one of a counter internal to the thread and a counter external to the thread, and the second counter is the other of the counter internal to the thread and the counter external to the thread.

7. The method of claim 6, wherein the first counter and the second counter are indexed to a size of the entropy pool.

8. The method of claim 3, further comprising:
extracting a plurality of random bits from the entropy pool;
generating a random number according to the plurality of random bits; and
performing a cryptographic operation according to the random number.

9. An apparatus for generating a random entropy pool in a processing system executing a plurality of processing threads, each of the processing threads having a processing result completed in non-deterministic temporal order in relation to other processing threads, comprising:
means for computing, in a first processing thread, a first processing thread state value according to a shapeless mixing operation operating on an initial thread state value and the processing result;
means for computing, in another processing thread having a subsequently completed processing result, another processing thread state value according to a further shapeless mixing operation operating on another initial thread state value or a previously computed processing thread state value and the subsequently completed processing result; and
means for computing a portion of the entropy pool from the processing thread state value and the another processing thread state value.

10. The apparatus of claim 9, wherein the further shapeless mixing operation is the shapeless mixing operation.

11. The apparatus of claim 10, wherein the processing system comprises a plurality of processors, each of the plurality of processors executing a differing one of the plurality of processing threads.

12. The apparatus of claim 11, wherein:
the means for computing, in the first processing thread having the processing result, the processing thread value according to the shapeless mixing operation operating on the initial thread state value and the processing result further comprises:
means for reading, in the first processing thread having the processing result, the initial thread state value from the entropy pool; and
means for writing, in the first processing thread having the processing result, the first processing thread state value to the entropy pool;
the means for computing, in the another processing thread having the subsequently completed processing result, the another processing thread state value according to the further shapeless mixing operation operating on the another initial thread state value or the previously computed processing thread state value and the subsequently completed processing result comprises:
means for reading, in the processing thread having the subsequently completed processing result, the processing thread state value from the entropy pool;
means for computing, in the processing thread having the subsequently completed processing result, the another processing thread state value according to the further shapeless mixing operation operating on another initial thread state value or the processing thread state value and the subsequently completed processing result; and
means for writing, in the processing thread having the subsequently completed processing result, the another processing thread state value to the entropy pool.

13. The apparatus of claim 12, wherein:
the initial thread state value is read from a first portion of the entropy pool;
the processing thread state value is written to a second portion of the entropy pool;
the processing thread state value is read from the second portion of the entropy pool; and
the another processing thread state value is written to a third portion of the thread pool.

14. The apparatus of claim 13, wherein the first portion of the entropy pool and the third portion of the entropy pool are determined according to a first counter, and the second portion of the entropy pool is determined according to a second counter, wherein the first counter is one of a counter internal to the thread and a counter external to the thread, and the second counter is the other of the counter internal to the thread and the counter external to the thread.

15. The apparatus of claim 14, wherein the first counter and the second counter are indexed to a size of the entropy pool.

16. The apparatus of claim 11, further comprising:
means for extracting a plurality of random bits from the entropy pool;
means for generating a random number according to the plurality of random bits; and
means for performing a cryptographic operation according to the random number.

17. An apparatus for generating a random entropy pool in a processing system executing a plurality of processing threads, each of the processing threads having a processing result completed in non-deterministic temporal order in relation to other processing threads, comprising:
at least one processor;
a memory, communicatively coupled to the at least one processor, the memory storing processor instructions for:
computing, in a first processing thread, a first processing thread state value according to a shapeless mixing operation operating on an initial thread state value and the processing result;
computing, in another processing thread having a subsequently completed processing result, another processing thread state value according to a further shapeless mixing operation operating on another initial thread state value or a previously computed processing thread state value and the subsequently completed processing result; and
computing a portion of the entropy pool from the processing thread state value and the another processing thread state value.

18. The apparatus of claim 17, wherein the further shapeless mixing operation is the shapeless mixing operation.

19. The apparatus of claim 18, wherein the processing system comprises a plurality of processors, each of the plurality of processors executing a differing one of the plurality of processing threads.

20. The apparatus of claim 19, wherein:
the processor instructions for computing, in the first processing thread having the processing result, the processing thread value according to the shapeless mixing operation operating on the initial thread state value and the processing result further comprise processor instructions for:
reading, in the first processing thread having the processing result, the initial thread state value from the entropy pool; and
writing, in the first processing thread having the processing result, the first processing thread state value to the entropy pool;
the processor instructions for computing, in the another processing thread having the subsequently completed processing result, the another processing thread state value according to the further shapeless mixing operation operating on the another initial thread state value or the previously computed processing thread state value and the subsequently completed processing result comprise processor instructions for:
reading, in the processing thread having the subsequently completed processing result, the processing thread state value from the entropy pool;
computing, in the processing thread having the subsequently completed processing result, the another processing thread state value according to the further shapeless mixing operation operating on another initial thread state value or the processing thread state value and the subsequently completed processing result; and
writing, in the processing thread having the subsequently completed processing result, the another processing thread state value to the entropy pool.
